(19) United States
(12) Patent Application Publication
(10) Pub. No.: US 2026/0137107 A1
(43) Pub. Date: May 21, 2026

(54) STICK-TYPE FARRO CONVENIENCE FOOD COMPOSITION BASED ON FERMENTATION PRODUCT OF ANCIENT GRAIN FARRO

(71) Applicant: GRAINON INC., Seoul (KR)

(72) Inventors: CHANG SUK AHN, Gyeonggi-do (KR); DONG HOON LEE, Gyeonggi-do (KR); SUN HWA KIM, Gyeongsangbuk-do (KR); HA YEONG LEE, Seoul (KR); SU SEOK JANG, Seoul (KR); SHIN YOUNG OH, Daegu (KR); YONG JIN JEONG, Daegu (KR)

(21) Appl. No.: 19/394,056

(22) Filed: Nov. 19, 2025

(30) Foreign Application Priority Data
Nov. 21, 2024 (KR) 10-2024-0166856

(51) Int. Cl. A23L 7/104

(52) U.S. Cl. CPC A23L 7/104; A23V 2400/169

(57) ABSTRACT

A method for producing a stick-type farro convenience food composition includes enzymatically treating ancient grain farro, fermenting the farro with lactic acid bacteria, mixing the resulting farro fermentation product with fermented calcium, indigestible maltodextrin, farro concentrate, steviol glycosides, and grain flavor, sterilizing the fermented farro mixture, and filling the mixture into stick-type packaging.

### CROSS-REFERENCE TO RELATED APPLICATION AND CLAIM OF PRIORITY

This application claims the benefit under 35 USC § 119 of Korea Patent Application No. 10-2024-0166856, filed on Nov. 21, 2025, in the Korea Intellectual Property Office, the entire disclosure of which is incorporated herein by reference for all purposes.

### BACKGROUND

### 1. Technical Field

The present invention relates to a method for producing a stick-type farro convenience food composition using a farro fermentation product obtained by enzyme treatment of ancient grain farro followed by lactic acid bacterial fermentation, and to a stick-type farro convenience food composition produced by the method.

### 2. Background Art

The scientific name of farro is Triticum dicoccon. It has been consumed for thousands of years in the Mediterranean and West Asian regions and is considered an ancient grain. Once regarded as a precious food known as ‘the wheat of the Pharaohs’ for millennia, the term ‘farro’ is actually a collective term that refers to three different types of wheat: einkorn wheat, emmer wheat, and spelt wheat. In the United States and European countries, it typically refers to emmer wheat.

Farro grows well in high-altitude, low-temperature, and dry regions, and is mainly cultivated in the Tuscany region of central Italy. Particularly in Tuscany, farro is grown in an eco-friendly manner without the use of chemical pesticides or fertilizers. In accordance with EU regulations, crop rotation is practiced to protect the soil and maintain grain quality. As farro is cultivated after a two-year fallow period, its grain quality is excellent.

Farro is rich in dietary fiber, vitamins, protein, magnesium, and minerals. Its high content of resistant starch and dietary fiber aids slow digestion in human, helping to prevent the rapid increase in blood glucose level (i.e., blood sugar spikes) and prolong satiety, while also being effective in preventing constipation. Additionally, farro is low in carbohydrate content and sugar level, making it suitable for blood sugar management when consumed as a whole grain. In fact, farro has an even lower sugar content than khorasan wheat, another ancient grain known for its low glycemic index, making it a distinctly low-sugar grain.

Farro also contains a variety of antioxidant compounds, including carotenoids, lutein, zeaxanthin, polyphenols, ferulic acid, and selenium. These components help boost the immune system and improve skin aging. In addition, it contains compounds such as arabinoxylan and phytosterols, which help lower cholesterol and fasting blood glucose levels when consumed, making it recommended for people with diabetes or those needing blood sugar control.

Industrial applications using enzymes have been explored across various industrial fields. Although process technologies for improving extraction yields during extraction processes for materialization or for reducing the molecular weight of unextractable components such as cellulose have been attempted many times, but have not been widely adopted.

Korean Patent Publication No. 2015-0028974 discloses a method for producing a grain mixture composition containing calcium, honey, cereal, and nuts. Korean Patent Publication No. 2023-0115498 discloses a method for producing a functional grain powder containing farro. However, they are different from the present invention, which relates to a stick-type farro convenience food composition based on a fermentation product of ancient grain farro.

### SUMMARY

The present invention is devised in response to the above-described needs. The objective of the present invention is to provide a method for producing a stick-type farro convenience food composition that has enhanced functionality through a two-step enzyme treatment and lactic acid bacterial fermentation of farro, and improved palatability by blending with selected sub-ingredients and optimized blending ratios, while also offering portability and ease of consumption.

To achieve the aforementioned objective, the present invention provides a method for producing a stick-type farro convenience food composition, the method including:
(1) preparing a farro solution by adding water to farro powder;
(2) performing a first enzyme treatment by adding α-amylase to the farro solution prepared in the step (1);
(3) performing a second enzyme treatment by adding β-amylase and oligozyme to the farro enzymatic solution obtained by the first enzyme treatment in the step (2);
(4) sterilizing and cooling the farro enzymatic solution obtained by the second enzyme treatment in the step (3);
(5) inoculating the cooled farro enzymatic solution in the step (4) with Lactobacillus plantarum and fermenting to produce a farro fermentation product; and
(6) sterilizing a fermented farro mixture obtained by mixing the farro fermentation product in the step (5) with fermented calcium, indigestible maltodextrin, farro concentrate, steviol glycoside, and grain flavor, and filling the mixture into stick-type packaging.

The present inventio further provides a stick-type farro convenience food composition produced by the above method.

The farro fermentation product used in the production of the stick-type farro convenience food composition according to the present invention has an increased content of specific functional components through two-step enzyme treatment and lactic acid bacterial fermentation. As a result, the stick-type convenience food composition using this fermentation product of the present invention offers the advantage of improved quality as a functional food.

Furthermore, the stick-type farro convenience food composition, in which the farro fermentation product of the present invention and other ingredients are properly blended, delivers excellent flavor and taste due to the harmonious combination of its components, while being conveniently packaged in a portable stick-type liquid form for easy consumption.

### BRIEF DESCRIPTION OF THE DRAWINGS

FIGS. 1A and 1B are graph comparing the arabinoxylan and ferulic acid content of samples before (PET) and after (30, 60, 90 minutes) (LTC) the treatment with liquefaction enzyme in a farro solution.

FIG. 2 is a graph comparing the ferulic acid content of samples (OTC) at different times (120, 240, 360 minutes) after the treatment with liquefaction enzyme.

### DETAILED DESCRIPTION

To solve the problems described above, the present invention provides a method for producing a stick-type farro convenience food composition, the method including:
(1) preparing a farro solution by adding water to farro powder;
(2) performing a first enzyme treatment by adding α-amylase to the farro solution prepared in the step (1);
(3) performing a second enzyme treatment by adding β-amylase and oligozyme to the farro enzymatic solution obtained by the first enzyme treatment in the step (2);
(4) sterilizing and cooling the farro enzymatic solution obtained by the second enzyme treatment in the step (3);
(5) inoculating the cooled farro enzymatic solution in the step (4) with Lactobacillus plantarum and fermenting to produce a farro fermentation product; and
(6) sterilizing a fermented farro mixture obtained by mixing the farro fermentation product in the step (5) with fermented calcium, indigestible maltodextrin, farro concentrate, steviol glycoside, and grain flavor, and filling the mixture into stick-type packaging.

In the method for producing a stick-type farro convenience food composition according to the present invention, the farro solution in the step (1) can be preferably prepared by adding 3 to 5 times (v/w) of water to farro powder ground to 20-40 mesh. More preferably, the farro solution can be prepared by adding 4 times (v/w) of water to farro powder ground to 30 mesh, resulting in a farro solution having concentration suitable for subsequent enzyme treatment.

Furthermore, in the method for producing a stick-type farro convenience food composition according to the present invention, the first enzyme treatment in the step (2) is preferably carried out by adding 0.05 to 0.15% (w/w) of α-amylase to the farro solution and enzymatically treating the mixture at 90-100° C. for 20 to 70 minutes. More preferably, α-amylase is added at 0.1% (w/w) and treatment is conducted at 95° C. for 30 or 60 minutes. The α-amylase used is a thermostable amylase with an optimal temperature range of 80-110° C. By performing the enzyme treatment under these conditions with α-amylase having such characteristics, the farro can be sufficiently gelatinized for subsequent saccharification, while increasing the mineral and ferulic acid content in the farro enzymatic solution and improving palatability during fermentation.

Furthermore, farro enzymatic solution treated with enzyme for 20 to 40 minutes shows increased levels of minerals such as calcium and zinc, as well as higher contents of arabinoxylan and ferulic acid, compared to groups not treated with any enzyme. Furthermore, enzymatic solution treated for 50 to 70 minutes with enzyme exhibited higher mineral contents—including calcium, magnesium, iron, and zinc—and increased ferulic acid levels compared to groups not treated with any enzyme. Additionally, enzymatic solution treated for 50 to 70 minutes with enzyme demonstrated greater levels of aspartic acid and dietary fiber compared to other enzyme treatment conditions.

Furthermore, in the method for producing a stick-type farro convenience food composition according to the present invention, the second enzyme treatment in the step (3) is preferably carried out by adding 0.05 to 0.15% (w/w) of β-amylase and 0.05 to 0.15% (w/w) of oligozyme to the farro enzymatic solution obtained from the first enzyme treatment, followed by enzyme treatment at 50-60° C. for 100 to 150 minutes. More preferably, β-amylase and oligozyme are each added at 0.1% (w/w) to the farro enzymatic solution obtained from the first enzyme treatment and enzyme treatment is performed at 55° C. for 120 minutes. The oligozyme is a glycosyltransferase. Enzyme treatment under those conditions can efficiently and sufficiently saccharify the farro solution, and also higher ferulic acid content and excellent palatability are obtained. However, if the enzyme treatment conditions exceed the specified ranges, there is a problem in that disaccharides are not properly converted to oligosaccharides, and the dietary fiber and ferulic acid contents decrease, which also negatively affects palatability.

Furthermore, in the method the method for producing a stick-type farro convenience food composition according to the present invention, the step (4) preferably involves sterilizing the farro enzymatic solution obtained by the second enzyme treatment at 90-100° C. for 5-15 minutes, followed by cooling to 30-40° C. More preferably, the farro enzymatic solution obtained by the second enzyme treatment can be sterilized at 95° C. for 10 minutes and then cooled to 30-40° C.

Furthermore, in the method for producing a stick-type farro convenience food composition according to the present invention, the farro fermentation product of the step (5) is preferably prepared by inoculating the farro enzymatic solution with Lactobacillus plantarum and fermenting at 30-40° C. for 20-30 hours. More preferably, the farro fermentation product can be prepared by inoculating the farro enzymatic solution with Lactobacillus plantarum and fermenting at 30-40° C. for 24 hours. By fermenting the farro enzymatic solution with lactic acid bacteria under the above conditions, the unique sour taste of farro can be complemented and its functional properties can be further improved.

Furthermore, in the method for producing a stick-type farro convenience food composition according to the present invention, the step (6) preferably involves sterilizing, at 90-100° C. for 5-15 minutes, a fermented farro mixture obtained by mixing, based on the total weight of the fermented farro mixture, 78-82% by weight of farro fermentation product with 0.05-0.15% by weight of fermented calcium, 13-17% by weight of indigestible maltodextrin, 3-7% by weight of farro concentrate, 0.03-0.07% by weight of steviol glycoside, and 0.03-0.07% by weight of grain flavor, and filling the mixture into stick-type packaging. More preferably, the step (6) involves sterilizing, at 95° C. for 10 minutes, a fermented farro mixture obtained by mixing, based on the total weight of the fermented farro mixture, 80% by weight of farro fermentation product with 0.1% by weight of fermented calcium, 15% by weight of indigestible maltodextrin, 4.8% by weight of farro concentrate, 0.05% by weight of steviol glycoside, and 0.05% by weight of grain flavor, and filling the mixture into stick-type packaging. The stick-type convenience food composition produced with those ingredients, blending ratios, and sterilization conditions exhibits a well-balanced taste and flavor, resulting in a composition with improved sensory profile.

The fermented calcium used in the preparation of the fermented farro mixture may specifically be prepared by the following steps of:
preparing a fermentation medium by mixing, based on the total weight of the medium, 78-82% by weight of water, 4-6% by weight of glucose, 2-4% by weight of malt, 0.5-1.5% by weight of yeast extract, 0.5-1.5% by weight of cellulase, and 8-12% by weight of acetic acid bacteria;
adding washed and coarsely ground oyster shell powder to the prepared fermentation medium and fermenting at 20-25° C. for 20-28 hours; and
washing the fermented oyster shell, drying and sterilizing it at 45-55° C. for 2-4 hours, followed by further drying at 75-85° C. for 20-28 hours to give fermented calcium.

More specifically, it may be prepared by the following steps of:
preparing a fermentation medium by mixing, based on the total weight of the medium, 80% by weight of water, 5% by weight of glucose, 3% by weight of malt, 1% by weight of yeast extract, 1% by weight of cellulase, and 10% by weight of acetic acid bacteria;
adding washed and coarsely ground oyster shell powder to the prepared fermentation medium and fermenting at 20-25° C. for 24 hours; and
washing the fermented oyster shell, drying and sterilizing it at 50° C. for 3 hours, followed by further drying at 80° C. for 24 hours to give fermented calcium.

Conventionally, natural calcium materials produced from oyster shells are produced through a calcination process at 600-900° C. in a kiln, which involves high energy consumption and results in significant carbon emissions. Additionally, the production process often faces issues such as precipitation, discoloration, and recrystallization, making it less environmentally friendly. However, by fermenting under the conditions described above to produce fermented calcium, environmental problems related to high energy consumption and carbon emissions can be effectively addressed. Moreover, using the fermented calcium produced as described in the present invention to produce the stick-type composition enhances bodily absorption and improves palatability.

The acetic acid bacteria used in the preparation of the fermented calcium may be Acetobacter pasteurianus KFC 819 (KCTC 10173BP), but it is not limited thereto.

Additionally, the farro concentrate is preferably prepared by concentrating the second enzyme-treated farro enzymatic solution to 60-70° Brix, and more preferably by concentrating the second enzyme-treated farro enzymatic solution to 65° Brix.

More specifically, the method for producing a stick-type farro convenience food composition according to the present invention may include the following steps of:
(1) preparing a farro solution by adding 3 to 5 times (v/w) of water to farro powder;
(2) performing a first enzyme treatment by adding α-amylase to the farro solution prepared in the step (1) and enzymatically treating the mixture at 90-100° C. for 20 to 70 minutes;
(3) performing a second enzyme treatment by adding β-amylase and oligozyme to the farro enzymatic solution obtained by the first enzyme treatment in the step (2) and enzymatically treating the mixture at 50-60° C. for 100 to 150 minutes;
(4) sterilizing the farro enzymatic solution obtained by the second enzyme treatment in the step (3) at 90-100° C. for 5-15 minutes, followed by cooling to 30-40° C.;
(5) inoculating the cooled farro enzymatic solution obtained in the step (4) with Lactobacillus plantarum and fermenting at 30-40° C. for 20-30 hours to produce a farro fermentation product; and
(6) sterilizing, at 90-100° C. for 5-15 minutes, a fermented farro mixture obtained by mixing, based on the total weight of the fermented farro mixture, 78-82% by weight of the farro fermentation product obtained in the step (5) with 0.05-0.15% by weight of fermented calcium, 13-17% by weight of indigestible maltodextrin, 3-7% by weight of farro concentrate, 0.03-0.07% by weight of steviol glycoside, and 0.03-0.07% by weight of grain flavor, and filling the mixture into stick-type packaging.

Even more specifically, the method for producing a stick-type farro convenience food composition according to the present invention may include the following steps of:
(1) preparing a farro solution by adding 4 times (v/w) of water to farro powder;
(2) performing a first enzyme treatment by adding α-amylase to the farro solution prepared in the step (1) and enzymatically treating the mixture at 95° C. for 60 minutes;
(3) performing a second enzyme treatment by adding β-amylase and oligozyme to the farro enzymatic solution obtained by the first enzyme treatment in the step (2) and enzymatically treating the mixture at 50-60° C. for 120 minutes;
(4) sterilizing the farro enzymatic solution obtained by the second enzyme treatment in the step (3) at 95° C. for 10 minutes, followed by cooling to 30-40° C.;
(5) inoculating the cooled farro enzymatic solution obtained in the step (4) with Lactobacillus plantarum and fermenting at 30-40° C. for 24 hours to produce a farro fermentation product; and
(6) sterilizing, at 95° C. for 10 minutes, a fermented farro mixture obtained by mixing, based on the total weight of the fermented farro mixture, 80% by weight of the farro fermentation product obtained in the step (5) with 0.1% by weight of fermented calcium, 15% by weight of indigestible maltodextrin, 4.8% by weight of farro concentrate, 0.05% by weight of steviol glycoside, and 0.05% by weight of grain flavor, and filling the mixture into stick-type packaging.

The present invention further provides a stick-type farro convenience food composition produced by the above method.

Hereinafter, the present invention will be described in greater detail with reference to the following Preparation examples and Examples. However, the following Preparation examples and Examples are provided solely to illustrate the present invention, and it is evident that the scope of the present invention is not limited to the following Preparation examples and Examples.

### EXAMPLES

### Preparation Example 1. Stick-Type Farro Convenience Food Composition (Fermented Farro Stick in Liquid Form)

(1) 400 g of farro powder, ground to 30 mesh from ancient grain farro (Farro Emmer), was mixed with tap water at 4 times the weight of the farro powder (v/w) to prepare a farro solution.
(2) To the farro solution prepared in the step (1), 0.1% (w/w) α-amylase (Biowin HT, optimal temperature 80-110° C., pH 5.5-6.5, Sunson Industry Group) was added, and a first enzyme treatment was performed at 95° C. and 50 rpm for 30 or 60 minutes.
(3) To the farro enzymatic solution prepared in the first enzyme treatment in the step (2), 0.1% (w/w) β-amylase (optimal temperature 50-60° C., pH 6.0-8.0, Senson OY) and 0.1% (w/w) oligozyme (optimal temperature 50-60° C., pH 6.0-8.0) were added, and a second enzyme treatment was performed at 55° C. for 120 minutes.
(4) The farro enzymatic solution after the second enzyme treatment in the step (3) was sterilized at 95° C. for 10 minutes and cooled to 30-40° C.
(5) To the cooled farro enzymatic solution obtained in the step (4), 5% (w/w) Lactobacillus plantarum (KCTC) culture at 2.0×10⁸ cfu/g was inoculated and fermented with stirring at 30-40° C. for 24 hours to prepare a farro fermentation product.
(6) Based on the total weight of the fermented farro mixture, 80% by weight of the farro fermentation product prepared in the step (5), 0.1% by weight of fermented calcium, 15% by weight of indigestible maltodextrin, 4.8% by weight of farro concentrate (65° Brix), 0.05% by weight of steviol glycosides, and 0.05% by weight of grain flavor were mixed. The fermented farro mixture was sterilized at 95° C. for 10 minutes and then filled into stick-type packaging.

### 1. Materials and Methods

### 1.1. Materials Used for Experiments

The ancient grain farro (Farro Emmer) used in this experiment was a variety cultivated and harvested in 2023 from the Tuscany region of Italy. To increase the content of functional components in the farro grain, liquefaction, saccharification, and simultaneous oligozyme processing were performed. Specifically, the liquefaction enzyme (α-amylase, Biowin HT, optimal temperature 80-110° C., pH 5.5-6.5, Sunson Industry Group) and saccharification enzyme (β-amylase, Betalase, optimal temperature 50-60° C., pH 6.0-8.0, Senson OY) were purchased from Vision Biochem Co., Ltd., and the oligozyme (optimal temperature 50-60° C., pH 6.0-8.0) was purchased from Soul Care Nutrition Co., Ltd. and used.

### 1.2. Preparation of Stick-Type Farro Convenience Food Composition

The farro enzymatic solution, obtained after the second enzyme treatment, was sterilized at 95° C. for 10 minutes and then cooled to 30-40° C. The cooled farro enzymatic solution was inoculated with 5% (w/w) of a Lactobacillus plantarum (KCTC) culture at 2.0×10⁸ cfu/g and fermented with stirring at 30-40° C. for 24 hours to produce a farro fermentation product.

The fermented farro mixture was prepared by mixing 80% by weight of the produced farro fermentation product with 0.1% by weight of fermented calcium, 15% by weight of resistant maltodextrin, 4.8% by weight of farro concentrate (65° Brix), 0.05% by weight of steviol glycoside, and 0.05% by weight of grain flavor. This mixture was sterilized at 95° C. for 10 minutes and then filled into stick-type packaging in 5 mL portions.

### 1.3. Examination of Quality Characteristics of Farro Enzymatic Solution

pH of the farro enzymatic solution samples was measured at room temperature using a pH meter (Orion Star AIII, Thermo Sci., Indonesia). Color analysis was performed using a colorimeter (CR-10, Konica Minolta Sensing Inc., Tokyo, Japan) to measure the L, a, and b values. The standard plates used had an L value of 100.00, an a value of 0.06, and a b value of −0.03, respectively. The sugar content was measured using a refractometer (PR-101, Atago Co., Tokyo, Japan) and expressed as ° Brix.

### 1.4. Analysis of Mineral Content

Mineral content of each sample was analyzed according to the AOAC method. Specifically, 5 g of the sample was taken and ashed at 500° C. in a muffle furnace for 2 hours, then cooled. To the ash, 0.5 mL of distilled water and 3 mL of nitric acid solution (HNO₃:H₂O=1:1) were added, and the mixture was heated on a 100° C. hot plate to remove excess nitric acid. It was then ashed again at 500° C. for 1 hour. Subsequently, the residue was diluted with hydrochloric acid solution (HCl:H₂O=1:1) to a final volume of 50 mL and used as the mineral analysis sample. Mineral analysis was performed using an Inductively Coupled Plasma Atomic Emission Spectrophotometer (ICP-AES, Jobin Yvon JY 38 Plus, Longjumeau, France). The wavelengths used for measurement of the minerals were as follows: Ca at 393.366 nm, K at 769.896 nm, Mg at 280.270 nm, Fe at 259.940 nm, Zn at 213.856 nm, and Se at 196.0 nm.

### 1.5. Analysis of Total Dietary Fiber Content

Total dietary fiber content of each sample was analyzed using a dietary fiber analyzer (TDFI, Ankom Technology, Macedon, NY, USA). First, for each sample, 0.5 g was placed into two separate TDF (total dietary fiber) bags A (IDF flow-thru, Ankom Technology). Then, 40 mL of MES-Tris buffer solution (Sigma, St. Louis, MO, USA) was added, and 50 μL of α-amylase (Megazyme, Wicklow, Ireland) was further added. The mixture was stirred and reacted at 97° C. for 30 minutes. After cooling to 60° C., 100 μL of protease (Megazyme) was added and stirred for 30 minutes at 60° C. pH of the sample was adjusted to 4.0-4.7 using 0.561 N HCl (OCI Co. Ltd., Seoul, Korea) and 6 N NaOH (OCI Co., Ltd.). Next, 300 μL of amyloglucosidase (Megazyme) was added to the sample and stirred at 60° C. for 30 minutes. After the reaction, each sample was transferred to a TDF bag B (SDF filter bag, Ankom Technology) containing 1 g of celite (Sigma). To stop the enzyme reaction and precipitate total dietary fiber, 225 mL of 95% (w/v) ethanol (OCI Co., Ltd.) was added, followed by filtration. The samples were then washed and filtered twice sequentially with 15 mL each of distilled water, 95% (w/v) ethanol, and 78% (w/v) ethanol. The samples were dried in a forced convection oven (252L, JSOF-250, JSR, Gongju, Korea) at 105° C. for 90 minutes, and the weight of the residue was measured. Of the two samples whose residue weight was measured, one was analyzed for protein content by the Kjeldahl method, and the other was ashed at 525° C. for 5 hours to measure the ash content. A control (i.e., blank) was run without the sample but using the same total dietary fiber analysis procedure. The total dietary fiber (TDF) content was calculated using the following equation and expressed as g per 100 g.

$$Total dietary fiber content ( g / 100 g , wet weight ) = ( R - P - A - B ) \times 100 / S$$

R: Weight of residue after enzyme treatment
P: Protein content of the sample
A: Ash content of the sample
B: Content of fat or other components (added as necessary)
S: Sample weight

### 1.6. Analysis of Free Sugar Content

Free sugar content in the farro enzymatic solution was analyzed using HPLC (high-performance liquid chromatography, Waters 2487, Waters Co., Milford, PA, USA) equipped with a refractive index (RI) detector. For each sample, 25 mL of distilled water or 50% ethanol solution was added to determine the weight, followed by heating at 85° C. for 25 minutes to extract sugars. After cooling to room temperature, the extraction solvent was replenished to its original weight. The extract was then filtered through a 45 μm membrane filter and used as the test sample. An amino (NH₂) column (3.9×300 mm, 10 μm, Waters Co.) was used for free sugar analysis, with detection conducted at 30° C. The mobile phase was 80% acetonitrile, applied under isocratic elution conditions. The flow rate was set at 1.0 mL/min, and the injection volume was 10 μL for carrying out the analysis. Standard substances including fructose, glucose, maltose, and sucrose (Sigma-Aldrich Co., St. Louis, MO, USA) were used to create a calibration curve, and sugar contents were calculated and expressed in mg/g.

### 1.7. Analysis of Free Amino Acid Content

Free amino acid content was determined as follows: 0.1 g of the sample was dissolved in 1 mL of 0.02 N HCl and left to dissolve for 24 hours. Then, 1 mL of this solution was mixed with an equal volume of 5% trichloroacetic acid (TCA) and stirred. The mixture was centrifuged at 10,000 rpm for 10 minutes (Labogene 1248, Gyrozen, Daejeon, Korea), and the supernatant was filtered through a 0.2 μm membrane filter to give the sample for free amino acid analysis. The analysis was performed using an amino acid analyzer (L-8900, Hitachi, Tokyo, Japan) under the following conditions: a 4.6 mm×60 mm ion-exchange column resin #2622SCPF (Hitachi, Tokyo, Japan), column temperature at 50° C., reactor temperature at 135° C., and injection volume of 20 μL. Free amino acid standards were used to prepare a calibration curve under the same conditions as the samples, and the content was calculated and expressed in μg/mL.

### 1.8. Analysis of Water Extractable Arabinoxylan Content

Water extractable arabinoxylan (WEAX) content was measured as follows: 125 mg of the sample was placed in a 50 mL tube, and 25 mL of distilled water was added. The mixture was stirred for 1 minute, then 1 mL of the suspension was transferred to another tube. The 1 mL suspension corresponds to 5 mg of the sample. After stirring the sample for 30 minutes, it was centrifuged at 1,000 g for 10 minutes (Labogene 1248, Gyrozen Co., Daejeon, Korea), and 1 mL of the supernatant was collected and transferred to a tube to prepare the sample. To each tube, 1 mL of distilled water and 10 mL of a reaction solution (prepared from 110 mL glacial acetic acid, 2 mL hydrochloric acid, 5 mL 20% phloroglucinol in absolute ethanol, and 1 mL 1.75% glucose) were added and mixed. The tubes were incubated in boiling water for 25 minutes, with vigorous mixing every 10 minutes. The reaction was terminated by placing the tubes in 0° C. water. Absorbance was measured at 552 nm and 510 nm using a spectrophotometer (UV-1800 240V, Shimadzu Co., Kyoto, Japan), and the absorbance at 510 nm was subtracted from that at 552 nm. The resulting value was compared with a xylose standard curve to calculate the water extractable arabinoxylan content. The xylose standard curve was prepared by dissolving 10 mg of D-(+)-xylose in 100 mL of distilled water. Aliquots of 0, 0.5, 1.0, 1.5, and 2.0 mL were dispensed into tubes, and distilled water was added to bring the final volume to 2 mL. Then, 10 mL of the reaction solution was added, and the tubes were incubated in boiling water for 25 minutes. Absorbance was measured at 552 nm and 510 nm, and a standard curve was generated to calculate the water extractable arabinoxylan content, expressed as mg/g.

### 1.9. Analysis of Ferulic Acid Content

Ferulic acid content of the sample was analyzed using HPLC (Waters Acquity UPLC H-Class, Waters, Singapore). The sample was dried at 40° C. for 12 hours, then 2 g of the dried sample was placed into a 250 mL flask. To this, 60 mL of 2 N NaOH and 0.001 g of sodium bisulfite were added, and the mixture was shaken at 180 rpm for 24 hours. The culture solution was centrifuged at 6,000 rpm and 4° C. for 20 minutes, and the supernatant was transferred to a separatory funnel. The pH was adjusted to below 2 by adding 10 N HCl, and the supernatant was separated. This acidification and separation process was repeated three times. The collected supernatant was concentrated using a rotary evaporator (Buchi Rotavapor R-205, Buchi Lab. AG, Switzerland) and then dissolved in 3 mL of acetonitrile:water (1:1, v/v) and stored refrigerated. For analysis, an ACQUITY UPLC HSS C18 column (1.8 μm, 2.1×100 mm) was used. As for the mobile phase, 1% acetic acid solution (solvent A) and acetonitrile (solvent B) were applied sequentially. The ferulic acid content was quantified using a standard calibration curve and expressed as mg/g.

### 1.10. Sensory Evaluation

Sensory evaluation was conducted with 20 food industry researcher participants who each consumed the stick-type farro convenience food composition. The participants assessed three attributes: flavor, taste, and overall preference. A 9-point hedonic scale was used for the evaluation (1: Dislike extremely, 2: Dislike very much, 3: Dislike, 4: Slightly dislike, 5: Neither like nor dislike, 6: Slightly like, 7: Like, 8: Like very much, 9: Like extremely). After evaluating each sample, the participants rinsed their mouths with purified water at room temperature before proceeding to the next evaluation.

### 1.11. Statistical Processing

All analytical results in the experiments of the present invention are presented as the mean±standard deviation (SD) of three repeated experiments. Statistical analysis for each experimental result was performed using a statistics program, i.e., SPSS software (version 22.0, SPSS Inc., USA). Significant differences between the means of each experimental group were determined by Duncan's multiple range test (p 0.05).

### Example 1. Changes in pH, Sweetness, and Color Depending on Liquefaction Conditions for Farro

As a first-step liquefaction experiment to enhance the utilization of farro grains, α-amylase (0.1% w/w) was mixed with farro samples and treated at 95° C. and 50 rpm for varying durations (30, 60, 90 minutes). Then, changes in pH, sweetness (° Brix), and color of the farro enzymatic solution according to treatment time are examined and shown in Table 1. The pH of the sample before liquefaction (PET) was 6.05, which slightly increased to 6.09 after 30 minutes of liquefaction. However, as the liquefaction time extended, the pH decreased to 5.93 and 5.96, respectively (p<0.05). The sweetness measured before liquefaction (PET) was 4.4° Brix, which slightly decreased to 3.6° Brix after 30 minutes, but significantly increased to 9.7° Brix and 12.6° Brix as the treatment time lengthened (p<0.05). Regarding color changes, before liquefaction (PET), the values were L=53.6, a=2.8, and b=23.1, indicating a bright turquoise color. After 30 minutes of liquefaction (LTC_30), the values were L=49.1, a=2.6, and b=23.2; after 60 minutes (LTC_60), L=50.1, a=2.1, and b=22.9; and after 90 minutes (LTC_90), L=49.3, a=2.3, and b=21.5, with no significant differences observed among them. These results are considered to result from the random hydrolysis of α-1,4 glycosidic bonds in starch during liquefaction, producing low-molecular-weight dextrins, oligosaccharides, maltose, and glucose.

TABLE 1
Changes in pH, sweetness, and color depending on liquefaction conditions for farro

| | | | LTC (min) | | | |
|---|---|---|---|---|---|---|
| Sample¹⁾ | | PET | 30 | 60 | 90 | F-value |
| pH | | 6.05 ± 0.01^{2)b3)} | 6.09 ± 0.02^{a} | 5.93 ± 0.01^{d} | 5.96 ± 0.01^{c} | 92.045*** |
| °Brix | | 4.40 ± 0.12^{c} | 3.6 ± 0.21^{d} | 9.7 ± 0.47^{b} | 12.6 ± 0.12^{a} | 758.830*** |
| Color | L | 53.60 ± 0.46^{a} | 49.1 ± 0.49^{c} | 50.1 ± 1.37^{b} | 49.3 ± 0.36^{b} | 21.731*** |
| difference | a | 2.80 ± 0.12^{a} | 2.6 ± 0.15^{ab} | 2.1 ± 0.31^{d} | 2.3 ± 0.10^{c} | 7.325* |
| | b | 23.1 ± 0.26^{a} | 23.2 ± 0.31^{a} | 22.9 ± 0.60^{ab} | 21.5 ± 1.35^{b} | 3.000 |

¹⁾PET: Sample before liquefaction enzyme treatment, LTC: Sample after liquefaction enzyme treatment
²⁾All values are presented as mean ± standard deviation
³⁾Different superscripts within the same row indicate significant differences (p < 0.05)

### Example 2. Changes in Mineral Content Depending on Liquefaction Conditions for Farro

As a first step liquefaction experiment to enhance the utilization of farro grains, α-amylase (0.1% w/w) was mixed with the farro sample and treated at 95° C. and 50 rpm for different durations (30, 60, 90 minutes), and changes in mineral content were investigated. The results are shown in Table 2. The total mineral content in farro grains ranged from 1.182 to 1.295 mg/g, with the minerals present in the order of potassium (K)>magnesium (Mg)>calcium (Ca)>zinc (Zn)>iron (Fe), while selenium (Se) was not detected. Potassium (K) content was highest, measuring 0.878 mg/g before liquefaction and 0.952 mg/g after 90 minutes of liquefaction, but no significant difference was observed. Calcium and zinc contents were higher in liquefied samples compared to before liquefaction. Magnesium and iron contents were higher in samples liquefied for 60 minutes or longer. Potassium, an alkaline element found in food, is an essential mineral for maintaining normal nerve and muscle functions, and magnesium is known to affect bone and tooth formation, nerve transmission, and enzyme activity.

TABLE 2
Mineral content changes depending on liquefaction conditions for farro (unit: mg/g)

| | | LTC (min) | | | |
|---|---|---|---|---|---|
| Sample¹⁾ | PET | 30 | 60 | 90 | F-value |
| Ca | 0.074 ± 0.003^{2)b3)} | 0.085 ± 0.007^{a} | 0.089 ± 0.004^{a} | 0.087 ± 0.001^{a} | 6.569* |
| Mg | 0.288 ± 0.010^{b} | 0.291 ± 0.021^{b} | 0.306 ± 0.014^{ab} | 0.323 ± 0.004^{a} | 4.413* |
| K | 0.878 ± 0.025 | 0.905 ± 0.065 | 0.928 ± 0.035 | 0.952 ± 0.011 | 1.944 |
| Fe | 0.008 ± 0.001^{b} | 0.008 ± 0.001^{ab} | 0.009 ± 0.001^{a} | 0.009 ± 0.001^{a} | 5.833* |
| Zn | 0.008 ± 0.001^{b} | 0.009 ± 0.001^{a} | 0.010 ± 0.001^{a} | 0.010 ± 0.0001^{a} | 8.000** |
| Se | ND⁴⁾ | ND | ND | ND | |
| Total | 1.182 ± 0.035^{b} | 1.213 ± 0.087^{ab} | 1.254 ± 0.050^{ab} | 1.295 ± 0.016^{a} | 2.495 |
| mineral | | | | | |
| content | | | | | |

¹⁾PET: Sample before liquefaction enzyme treatment, LTC: Sample after liquefaction enzyme treatment
²⁾All values are presented as mean ± standard deviation
³⁾Different superscripts within the same row indicate significant differences (p < 0.05)
⁴⁾ND: Not detected

### Example 3. Changes in Total Dietary Fiber Content Depending on Liquefaction Conditions for Farro

As a first step to increase the utilization of farro grains, the change in total dietary fiber content according to the liquefaction time (30, 60, 90 minutes) at 95° C. and 50 rpm with 0.1% (w/w) α-amylase mixed with the farro sample was investigated, and the results are shown in Table 3. The total dietary fiber content of farro before liquefaction treatment (PET) was 5.68 g/100 g, but it sharply decreased to 2.93 g/100 g after 30 minutes of liquefaction (LTC_30), then tended to increase to 4.53 g/100 g at 60 minutes of liquefaction (LTC_60). The water extractable dietary fiber content of the samples tended to be slightly higher than the water unextractable dietary fiber content, and the water extractable dietary fiber content was highest at 60 minutes of liquefaction compared to other liquefaction times.

TABLE 3
Changes in total dietary fiber content depending on
liquefaction conditions for farro (unit: g/100 g)

| | | LTC (min) | | | |
|---|---|---|---|---|---|
| Sample¹⁾ | PET | 30 | 60 | 90 | F-value |
| Total dietary | 5.68 ± 0.44^{2)a3)} | 2.93 ± 0.89^{c} | 4.53 ± 0.16^{b} | 4.13 ± 0.35^{b} | 13.278** |
| fiber content | | | | | |
| Water | 3.14 ± 0.30^{a} | 1.75 ± 0.38^{d} | 2.55 ± 0.13^{b} | 2.23 ± 0.21^{c} | 13.738** |
| extractables | | | | | |
| Water | 2.54 ± 0.18^{a} | 1.18 ± 0.53^{c} | 1.98 ± 0.04^{b} | 1.90 ± 0.16^{b} | 10.962** |
| unextractables | | | | | |

¹⁾PET: Sample before liquefaction enzyme treatment, LTC: Sample after liquefaction enzyme treatment
²⁾All values are mean ± standard deviation
³⁾Different superscripts within the same row indicate significant differences (p < 0.05)

### Example 4. Changes in Free Sugar Content Depending on Liquefaction Conditions for Farro

As a first step experiment to enhance the utilization of farro grains, the changes in free sugar content were investigated by mixing 0.1% (w/w) α-amylase and treating at 95° C. and 50 rpm for different durations (30, 60, 90 minutes), with the results shown in Table 4. Before liquefaction (PET), the contents of fructose, glucose, maltose, and sucrose in farro grains were 8.75, 18.78, 23.81, and 0.98 mg/g, respectively, with maltose having the highest content. The results showed that, as the liquefaction time increased, the contents of fructose, glucose, and sucrose decreased, while the maltose content increased.

TABLE 4
Changes in free sugar content depending on liquefaction conditions for farro (unit: mg/g)

| | | LTC (min) | | | |
|---|---|---|---|---|---|
| Sample¹⁾ | PET | 30 | 60 | 90 | F-value |
| Fructose | 8.75 ± 0.90²⁾¹³⁾ | 1.16 ± 0.01^{4)d} | 1.82 ± 0.18^{c} | 2.68 ± 0.40^{b} | 423.952*** |
| Glucose | 18.78 ± 0.63^{a} | 4.46 ± 0.13^{c} | 4.14 ± 0.29^{c} | 6.27 ± 0.51^{b} | 761.000*** |
| Maltose | 23.81 ± 1.50^{d} | 264.62 ± 4.99^{c} | 360.40 ± 7.14^{a} | 355.70 ± 8.16^{b} | 5055.012*** |
| Sucrose | 0.98 ± 0.20^{a} | 0.76 ± 0.06^{b} | 0.68 ± 0.06^{b} | 0.57 ± 0.06^{b} | 6.815* |
| Total free | 52.32 ± 3.20^{d} | 270.99 ± 5.07^{c} | 367.04 ± 7.38^{a} | 365.22 ± 8.87^{b} | 3469.240*** |
| sugar content | | | | | |

¹⁾PET: Sample before liquefaction enzyme treatment, LTC: Sample after liquefaction enzyme treatment
²⁾All values are mean ± standard deviation
³⁾Different superscripts within the same row indicate significant differences (p < 0.05)

### Example 5. Changes in Free Amino Acid Content Depending on Liquefaction Conditions for Farro

As a first step to enhance the utilization of farro grains, changes in free amino acid content according to liquefaction time (30, 60, 90 minutes) were investigated by mixing 0.1% (w/w) α-amylase and treating at 95° C. and 50 rpm. The results are shown in Table 5. Before liquefaction treatment (PET), the total free amino acid content in farro grains was 96.45 μg/mL, but after liquefaction treatment, it decreased to levels between 24.78 and 20.88 μg/mL. Cysteine, methionine, and isoleucine were not detected. The content of tryptophan showed little change depending on the liquefaction time, while the content of aspartic acid was highest after 60 minutes of liquefaction.

TABLE 5
Changes in free amino acid content depending on liquefaction conditions for farro (unit: μg/mL)

| | | LTC (min) | | | |
|---|---|---|---|---|---|
| Sample¹⁾ | PET | 30 | 60 | 90 | F-value |
| Threonine | 3.50 ± 0.02^{2)a3)} | 0.73 ± 0.03^{b} | 0.70 ± 0.01^{c} | 0.66 ± 0.01^{c} | 16403.124*** |
| Cysteine | 0.42 ± 0.00 | ND⁴⁾ | ND | ND | |
| Tyrosine | 2.15 ± 0.02^{a} | 0.68 ± 0.02^{b} | ND^{d} | 0.24 ± 0.01^{c} | 15892.381*** |
| Arginine | 11.16 ± 0.05^{a} | 3.07 ± 0.05^{b} | 0.19 ± 0.03^{c} | 0.13 ± 0.01^{c} | 64448.642*** |
| Alanine | 5.98 ± 0.02^{a} | 2.22 ± 0.02^{b} | 1.37 ± 0.01^{d} | 1.75 ± 0.02^{c} | 42977.506*** |
| Proline | 13.60 ± 0.48^{a} | 1.95 ± 0.14^{b} | 2.30 ± 0.20^{b} | 2.19 ± 0.10^{b} | 1312.891*** |
| Lysine | 2.09 ± 0.02^{a} | 0.22 ± 0.02^{b} | ND^{c} | ND^{c} | 23194.250*** |
| Histidine | 1.76 ± 0.02^{a} | 0.68 ± 0.09^{b} | 0.69 ± 0.01^{b} | 0.58 ± 0.02^{c} | 446.597*** |
| Isoleucine | 2.94 ± 0.02^{a} | ND^{b} | ND^{b} | ND^{b} | 59704.692*** |
| Leucine | 7.08 ± 0.03^{a} | 0.17 ± 0.02^{b} | ND^{c} | ND^{c} | 130601.412*** |
| Methionine | 1.80 ± 0.01^{a} | ND^{b} | ND^{b} | ND^{b} | 97200.000*** |
| Phenylalanine | 7.41 ± 0.05^{a} | 0.43 ± 0.02^{b} | ND^{c} | ND^{c} | 68085.271*** |
| Tryptophan | 4.23 ± 0.03^{a} | 3.56 ± 0.10^{b} | 3.56 ± 0.02^{b} | 3.51 ± 0.06^{b} | 102.992*** |
| Valine | 4.62 ± 0.02^{a} | 0.47 ± 0.03^{b} | 0.28 ± 0.01^{c} | 0.30 ± 0.01^{c} | 42162.462*** |
| Glutamic acid | 9.15 ± 0.06^{a} | 2.12 ± 0.06^{c} | 1.90 ± 0.01^{d} | 2.41 ± 0.06^{b} | 14161.383*** |
| Aspartic acid | 7.90 ± 0.22^{a} | 6.18 ± 0.15^{c} | 7.78 ± 0.14^{a} | 7.43 ± 0.08^{b} | 73.960*** |
| Serine | 6.75 ± 0.05^{a} | 0.78 ± 0.02^{b} | 0.80 ± 0.01^{b} | 0.63 ± 0.01^{c} | 37865.984*** |
| Glycine | 3.93 ± 0.03^{a} | 1.51 ± 0.37^{b} | 1.31 ± 0.01^{d} | 1.39 ± 0.01^{c} | 11518.027*** |
| Total free | 96.45 ± 0.65^{a} | 24.78 ± 0.47^{b} | 20.88 ± 0.32^{c} | 21.22 ± 0.15^{c} | 21582.543*** |
| amino acid | | | | | |
| content | | | | | |

¹⁾PET: Sample before liquefaction enzyme treatment, LTC: Sample after liquefaction enzyme treatment
²⁾All values are presented as mean ± standard deviation
³⁾Different superscripts within the same row indicate significant differences (p < 0.05)
⁴⁾ND: Not detected

### Example 6. Changes in Arabinoxylan and Ferulic Acid Content Depending on Liquefaction Conditions for Farro

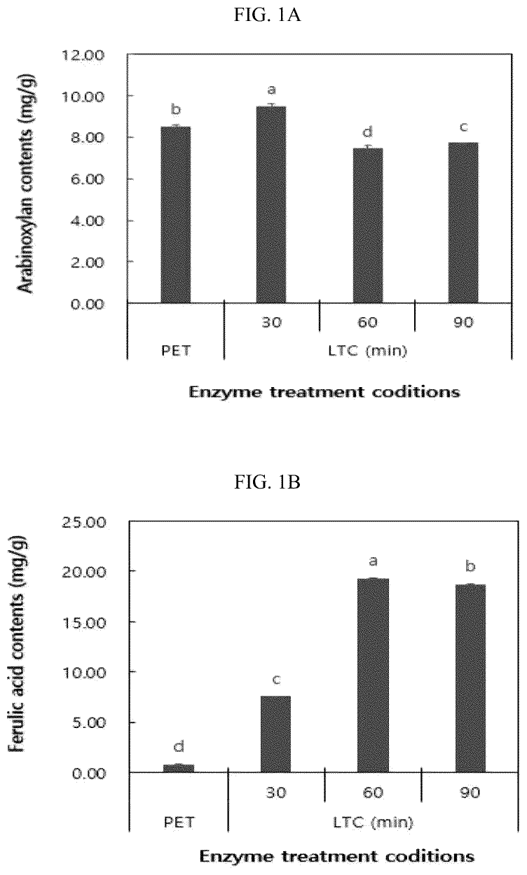

As a first step to enhance the utilization of farro grains, changes in arabinoxylan and ferulic acid contents according to liquefaction time (30, 60, 90 minutes) were compared by mixing 0.1% (w/w) α-amylase and treating at 95° C. and 50 rpm. The results are shown in FIG. 1. The arabinoxylan content changed with liquefaction time, showing 8.52 mg/g before liquefaction (PET), and 9.49 mg/g, 7.45 mg/g, and 7.72 mg/g at 30, 60, and 90 minutes of liquefaction (LTC_30, 60, 90), respectively, showing an increase at 30 minutes. Arabinoxylan, one type of dietary fiber, is a polysaccharide present as hemicellulose in the cell walls of gramineous plants such as rice, wheat, corn, and barley, and is composed of xylose (a monosaccharide) and arabinose (a monosaccharide). Arabinoxylan has been reported to have physiological activities such as antioxidant effects, enhancement of cancer cell cytotoxicity, and activation of immune cells.

Changes in ferulic acid content according to liquefaction time showed a very low content of 0.77 mg/g before liquefaction (PET), but increased significantly to 7.57 mg/g, 19.29 mg/g, and 18.69 mg/g at 30, 60, and 90 minutes of liquefaction, respectively. Ferulic acid is a type of plant polyphenol found in plant cell walls and accounts for about 90% of phenolic compounds in grains, also serving as a precursor for bioactive substances.

### Example 7. Changes in Physicochemical Properties Depending on Saccharification Conditions for Farro

As a result of the above Examples, the optimal liquefaction condition showing high contents of certain minerals and ferulic acid was determined to be 60 minutes of treatment, while the optimal liquefaction condition showing high contents of certain minerals and arabinoxylan was determined as 30 minutes of treatment. Among the liquefaction conditions, after mixing 0.1% (w/w) α-amylase into the farro solution, liquefaction was performed at 50 rpm for 60 minutes. Then, β-amylase (0.1% (w/w)) and oligo-xylanase (0.1% (w/w)) were respectively added to the liquefied sample and incubated at 55° C. and 55 rpm. Changes in pH, sweetness (° Brix), and color according to incubation times (120, 240, and 360 minutes) were investigated, and the results are shown in Table 6.

Based on the first step liquefaction condition for farro grain (95° C., 50 rpm, 60 minutes), pH and color values were measured during the third step saccharification time (OTC). The changes in pH and color were minimal, but the sweetness showed an increasing trend as the saccharification time increased (p<0.05). The pH of the farro fermentation product after the first step liquefaction for 60 minutes was 5.93, and during the third step treatment, the pH ranged from 5.92 to 5.94 without significant differences. The sweetness changed from 9.70° Brix in the first step liquefaction to 17.8° Brix, 18.5° Brix, and 19.0° Brix during the third step saccharification times OTC_120, OTC_240, and OTC_360, respectively, showing a tendency to slightly increase with longer saccharification time (p<0.05). For color changes, the farro fermentation product after the first step liquefaction for 60 minutes had L value of 50.1, a value of 2.1, and b value of 22.9, and no significant difference in color was observed regardless of saccharification time.

TABLE 6
Changes in physicochemical properties depending on saccharification conditions for farro

| | | | OTC (min) | | | |
|---|---|---|---|---|---|---|
| Sample¹⁾ | | LTC | 120 | 240 | 360 | F-value |
| pH | | 5.93 ± 0.01^{2)a3)} | 5.93 ± 0.03^{a} | 5.94 ± 0.02^{a} | 5.92 ± 0.01^{a} | 0.333 |
| °Brix | | 9.7 ± 0.47^{d} | 17.8 ± 0.25^{c} | 18.5 ± 0.20^{b} | 19.0 ± 0.01^{a} | 679.223*** |
| Color | L | 50.1 ± 1.37^{a} | 46.7 ± 1.57^{b} | 47.3 ± 0.44^{b} | 46.2 ± 0.81^{b} | 9.842** |
| difference | a | 2.1 ± 0.31^{a} | 0.9 ± 0.64^{b} | 1.7 ± 0.91^{a} | 1.6 ± 0.32^{ab} | 4.715* |
| | b | 22.9 ± 0.60^{a} | 21.9 ± 0.21^{b} | 22.7 ± 0.47^{ab} | 21.9 ± 0.31^{b} | 4.276* |

¹⁾LTC: Sample after liquefaction enzyme treatment, OTC: Sample treated with saccharification enzyme after liquefaction enzyme treatment
²⁾All values are mean ± standard deviation
³⁾Different superscripts within the same row indicate significant differences (p < 0.05)

### Example 8. Changes in Total Dietary Fiber Content Depending on Saccharification Conditions for Farro

After mixing α-amylase (0.1% (w/w)) with farro solution and liquefying at 50 rpm for 60 minutes, β-amylase (0.1% (w/w)) and oligozyme (0.1% (w/w)) were each added to the liquefied sample and saccharified at 55° C. and 55 rpm. The changes in total dietary fiber content over time (120, 240, and 360 minutes) were investigated, and the results are shown in Table 7. The results indicated that the dietary fiber content decreased after 360 minutes of saccharification in the enzymatic solution liquefied for 60 minutes. Up to 120 minutes of the saccharification, there were no significant differences in both water extractable and water unextractable dietary fiber contents compared to the untreated saccharification sample (p<0.05).

TABLE 7
Changes in total dietary fiber content depending on
saccharification conditions for farro (unit: g/100 g)

| | | OTC (min) | | | |
|---|---|---|---|---|---|
| Sample¹⁾ | LTC | 120 | 240 | 360 | F-value |
| Total dietary fiber | 4.53 ± 0.16^{2)a3)} | 4.51 ± 0.02^{a} | 4.40 ± 0.03^{a} | 3.95 ± 0.03^{b} | 30.043*** |
| content | | | | | |
| Water extractables | 2.55 ± 0.13^{a} | 2.53 ± 0.01^{a} | 2.47 ± 0.01^{a} | 2.25 ± 0.01^{b} | 12.591** |
| Water unextractables | 1.98 ± 0.04^{a} | 1.98 ± 0.01^{a} | 1.92 ± 0.01^{b} | 1.69 ± 0.01^{c} | 96.271*** |

¹⁾LTC: Sample after liquefaction enzyme treatment, OTC: Sample treated with saccharification enzyme after liquefaction enzyme treatment
²⁾All values are mean ± standard deviation
³⁾Different superscripts within the same row indicate significant differences (p < 0.05)

### Example 9. Changes in Free Sugar Content Depending on Saccharification Conditions for Farro

After mixing α-amylase (0.1% (w/w)) with farro solution and liquefying at 50 rpm for 60 minutes, β-amylase (0.1% (w/w)) and oligozyme (0.1% (w/w)) were each added to the liquefied sample and saccharified at 55° C. and 55 rpm. The changes in free sugar content over time (120, 240, and 360 minutes) were investigated, and the results are shown in Table 8. Following the first step liquefaction (95° C., 50 rpm, 60 minutes), fructose content significantly decreased with increasing third step saccharification time (OTC_120, 240, 360 minutes) (p<0.05), while maltose and total free sugar contents tended to decrease as the saccharification time increased. Glucose and sucrose contents showed little change over the third step saccharification times, but maltose content showed a decreasing trend. These results indicate lower content than the fructose (8.75 mg/g) and glucose (18.78 mg/g) contents in the farro sample before liquefaction (PET), while higher content than the maltose (23.81 mg/g) and sucrose (0.98 mg/g) contents.

TABLE 8
Changes in free sugar content depending on saccharification conditions for farro (unit: mg/g)

| | | OTC (min) | | | |
|---|---|---|---|---|---|
| Sample¹⁾ | LTC | 120 | 240 | 360 | F-value |
| Fructose | 1.82 ± 0.18^{2)a3)} | 0.93 ± 0.12^{b} | 0.86 ± 0.01^{b} | 0.84 ± 0.03^{b} | 52.136*** |
| Glucose | 4.14 ± 0.29^{b} | 5.52 ± 0.42^{a} | 5.43 ± 0.17^{a} | 5.29 ± 0.09^{a} | 16.296*** |
| Maltose | 360.40 ± 7.14^{c} | 480.83 ± 9.11^{a} | 384.37 ± 5.78^{b} | 367.73 ± 2.23^{b} | 189.165*** |
| Sucrose | 0.68 ± 0.06^{b} | 5.85 ± 0.19^{a} | 5.83 ± 0.03^{a} | 5.78 ± 0.09^{a} | 695.543*** |
| Total sugar | 367.04 ± 7.38^{c} | 493.12 ± 9.30^{a} | 396.49 ± 5.75^{b} | 392.98 ± 4.21^{b} | 190.937*** |
| content | | | | | |

¹⁾LTC: Sample after liquefaction enzyme treatment, OTC: Sample treated with saccharification enzyme after liquefaction enzyme treatment
²⁾All values are mean ± standard deviation
³⁾Different superscripts within the same row indicate significant differences (p < 0.05)

### Example 10. Changes in Ferulic Acid Content Depending on Saccharification Conditions for Farro

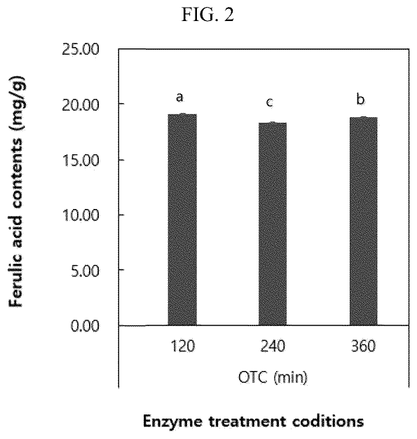

After mixing α-amylase (0.1% (w/w)) with farro solution and liquefying at 50 rpm for 60 minutes, β-amylase (0.1% (w/w)) and oligozyme (0.1% (w/w)) were each added to the liquefied sample and saccharified at 55° C. and 55 rpm. The changes in ferulic acid content over time (120, 240, 360 minutes) were investigated, and the results are shown in FIG. 2. Ferulic acid contents for the third step saccharification times (OTC_120, 240, 360 minutes) were 19.14, 18.39, and 18.85 mg/g, respectively, with the highest content observed at 120 minutes of saccharification.

### Example 11. Quality Characteristics of Stick-Type Farro Convenience Food Composition

The quality characteristics of the stick-type farro convenience food composition from Preparation example 1 are shown in Table 9. As a result, the total dietary fiber content, known to help maintain a feeling of fullness for a long time and aid in anti-obesity, was high at 15.4%. Additionally, ferulic acid content was high at 56.95 mg/g, and the ratio of calcium to magnesium was 2:1, which is considered the ideal (golden) ratio. Moreover, total bacterial count and Escherichia coli were not detected, indicating good storage stability.

TABLE 9
Quality characteristics of stick-type
farro convenience food composition

| Item | Results | |
|---|---|---|
| Total fibrous materials | 15.4% | |
| Ferulic acid | 56.95 | mg/g |
| Calcium | 7.2 | mg/g |
| magnesium | 3.7 | mg/g |
| Brix | 41.5 | |
| pH | 5.6 | |
| Viscosity (dPa · s) | 15 | dPa · s |

| | |
|---|---|
| Total bacterial count | ND |
| Escherichia coli, Escherichia coli group | ND |

### Example 12. Sensory Evaluation of Stick-Type Farro Convenience Food Composition

A sensory evaluation was conducted to investigate the effect on sensory properties using the stick-type farro convenience food composition from Preparation example 1 and compositions (Comparative examples 1 and 2) prepared by the same method as Preparation example 1 but with different ingredient blending ratios in the step (7).

TABLE 10
Blending ratio for stick-type farro convenience
food composition (% by weight)

| | Preparation | Comparative | Comparative |
|---|---|---|---|
| Ingredient | example 1 | example 1 | example 2 |
| Farro fermentation production | 80 | 76 | 83 |
| Fermented calcium | 0.1 | 0.01 | 0.2 |
| Indigestible maltodextrin | 15 | 22 | 8 |
| Farro concentrate | 4.8 | 1.88 | 8.69 |
| Steviol glycoside | 0.05 | 0.01 | 0.1 |
| Grain flavor | 0.05 | 0.1 | 0.01 |
| Total | 100 | 100 | 100 |

The sensory evaluation results showed that, overall, the stick-type farro convenience food composition of Preparation example 1 received higher preference scores compared to the Comparative examples, indicating that the ingredient blending ratio of Preparation example 1 is the most optimal.

TABLE 11
Results of sensory evaluation of stick-
type farro convenience food composition

| Composition type | Flavor | Taste | Overall preference |
|---|---|---|---|
| Preparation example 1 | 7.4 | 7.8 | 7.6 |
| Comparative example 1 | 6.2 | 6.0 | 6.0 |
| Comparative example 2 | 6.0 | 5.8 | 5.8 |

What is claimed is:

1. A method for producing a stick-type farro convenience food composition, the method comprising:
preparing a farro solution by adding water to farro powder;
performing a first enzyme treatment by adding α-amylase to the farro solution to prepare a first farro enzymatic solution;
performing a second enzyme treatment by adding β-amylase and oligozyme to the first farro enzymatic solution to prepare a second farro enzymatic solution;
sterilizing and cooling the second farro enzymatic solution;
inoculating the sterilized and cooled second farro enzymatic solution with Lactobacillus plantarum and fermenting to produce a farro fermentation product;
mixing the farro fermentation product with fermented calcium, indigestible maltodextrin, farro concentrate, steviol glycoside, and grain flavor to prepare a fermented farro mixture;
sterilizing the fermented farro mixture; and
filling the fermented farro mixture into stick-type packaging.

2. The method of claim 1, wherein the mixing comprises mixing, based on the total weight of the fermented farro mixture, 78-82% by weight of the farro fermentation product with 0.05-0.15% by weight of the fermented calcium, 13-17% by weight of the indigestible maltodextrin, 3-7% by weight of the farro concentrate, 0.03-0.07% by weight of the steviol glycoside, and 0.03-0.07% by weight of the grain flavor.

3. The method of claim 1, wherein the production is made by including the steps of:
wherein the performing of the first enzyme treatment comprises adding the α-amylase to the farro solution to prepare a first mixture and enzymatically treating the first mixture at 90-100° C. for 20 to 70 minutes to prepare the first farro enzymatic solution,
the performing of the second enzyme treatment comprises adding β-amylase and oligozyme to the first farro enzymatic solution to prepare a second mixture and enzymatically treating the second mixture at 50-60° C. for 100 to 150 minutes to prepare the second farro enzymatic solution;
the inoculating comprises inoculating the sterilized and cooled second farro enzymatic solution with the Lactobacillus plantarum and fermenting at 30-40° C. for 20-30 hours to produce a farro fermentation product;
the mixing comprises mixing, based on the total weight of the fermented farro mixture, 78-82% by weight of the farro fermentation product with 0.05-0.15% by weight of the fermented calcium, 13-17% by weight of the indigestible maltodextrin, 3-7% by weight of the farro concentrate, 0.03-0.07% by weight of the steviol glycoside, and 0.03-0.07% by weight of the grain flavor; and
the sterilizing comprises sterilizing, at 90-100° C. for 5-15 minutes, the fermented farro mixture.

4. A stick-type farro convenience food composition produced by the method of claim 1.

5. A method for producing a stick-type farro convenience food composition, the method comprising:
preparing a farro solution by adding 3 to 5 times (v/w) of water to farro powder;
performing a first enzyme treatment by adding α-amylase to the farro solution to prepare a first mixture and enzymatically treating the first mixture at 90-100° C. for 20 to 70 minutes to prepare a first farro enzymatic solution;
performing a second enzyme treatment by adding β-amylase and oligozyme to the first farro enzymatic solution to prepare a second mixture and enzymatically treating the second mixture at 50-60° C. for 100 to 150 minutes to prepare a second farro enzymatic solution;
sterilizing the second farro enzymatic solution at 90-100° C. for 5-15 minutes, followed by cooling to 30-40° C.;
inoculating the sterilized and cooled second farro enzymatic solution with the Lactobacillus plantarum and fermenting at 30-40° C. for 20-30 hours to produce a farro fermentation product;
mixing, based on the total weight of a fermented farro mixture, 78-82% by weight of the farro fermentation product with 0.05-0.15% by weight of fermented calcium, 13-17% by weight of indigestible maltodextrin, 3-7% by weight of farro concentrate, 0.03-0.07% by weight of steviol glycoside, and 0.03-0.07% by weight of grain flavor to prepare the fermented farro mixture;
sterilizing, at 90-100° C. for 5-15 minutes, the fermented farro mixture; and
filling the fermented farro mixture into stick-type packaging.

6. A stick-type farro convenience food composition produced by the method of claim 5.
